(19) United States
(12) Patent Application Publication
(10) Pub. No.: US 2022/0137823 A1
(43) Pub. Date: May 5, 2022

(54) Method and System for Improving Write Performance in a Storage System

(71) Applicant: EMC IP Holding Company LLC, Hopkinton, MA (US)

(72) Inventors: Uri Shabi, Tel Mond (IL); Amitai Alkalay, Kadima (IL)

(73) Assignee: EMC IP Holding Company LLC, Hopkinton, MA (US)

(21) Appl. No.: 17/083,480

(22) Filed: Oct. 29, 2020

(51) Int. Cl. G06F 3/06

(52) U.S. Cl. CPC G06F 3/0611; G06F 3/0659; G06F 3/0683; G06F 3/0629; G06F 3/067; G06F 3/064

(57) ABSTRACT

A method is used in improving write performance in a storage system. Data is stored on a first tier of storage. A modification to the data is stored on a second tier of storage, the second tier being higher than the first tier. Setting an indicator identifies which data is valid.

### BACKGROUND

### Technical Field

This application relates to improving write performance in a storage system.

### Description of Related Art

Computer systems may include different resources used by one or more host processors. Resources and host processors in a computer system may be interconnected by one or more communication connections. These resources may include, for example, data storage devices. These data storage systems may be coupled to one or more servers or host processors and provide storage services to each host processor. Multiple data storage systems from one or more different vendors may be connected and may provide common data storage for one or more host processors in a computer system.

A host processor may perform a variety of data processing tasks and operations using the data storage system. For example, a host processor may perform basic system I/O operations in connection with data requests, such as data read and write operations. Host processor systems may store and retrieve data using a storage device containing a plurality of host interface units, disk drives, and disk interface units. The host systems access the storage device through a plurality of channels provided therewith.

Host systems provide data and access control information through the channels to the storage device and the storage device provides data to the host systems also through the channels. The host systems do not address the drives of the storage device directly, but rather, access what appears to the host systems as a plurality of logical units. The logical units may or may not correspond to the actual drives. Allowing multiple host systems to access the single storage device unit allows the host systems to share data in the device. In order to facilitate sharing of the data on the device, additional software on the data storage systems may also be used.

Such a data storage system typically includes processing circuitry and a set of drives. In general, the processing circuitry performs load and store operations on the set of drives on behalf of the host devices. In certain data storage systems, the drives of the data storage system are distributed among one or more separate drive enclosures (drive enclosures are also referred to herein as “storage arrays”) and processing circuitry serves as a front-end to the drive enclosures. The processing circuitry presents the drive enclosures to the host device as a single, logical storage location and allows the host device to access the drives such that the individual drives and drive enclosures are transparent to the host device.

Storage arrays today manage many storage devices that are not identical. Storage arrays use different types of drives and group the like kinds of drives into tiers based on the performance characteristics of the drives. Exemplary storage devices include tape drives, flash memory, flash drives, other solid state drives, or some combination of the above. Additional exemplary storage devices include hard disk drives and optical disks.

Additionally, storage devices may be organized into tiers or classes of storage based on characteristics of associated storage media. A group of fast but small storage devices may be a fast tier, while a group of slow but large drives may be a slow tier. For example, flash-based storage device, hard disk-based storage devices, and tape-based storage devices may be assigned to different tiers of storage, in accordance with their access times. It may be possible to have different tiers with different properties or constructed from a mix of different types of physical drives to achieve a performance or price goal.

Storage arrays are typically used to provide storage space for one or more computer file systems, databases, applications, and the like. For this and other reasons, it is common for storage arrays to be structured into logical partitions of storage space, called logical units (also referred to herein as LUs or LUNs). For example, at LUN creation time, storage system may allocate storage space of various storage devices to be presented as a logical volume for use by an external host device. This allows a storage array to appear as a collection of separate file systems, network drives, and/or volumes.

Moreover, data storage systems employ various logical structures in memory for organizing data, including logical structures such as a namespace, a mapper, virtual layer blocks (VLBs), and physical layer blocks (PLBs). A namespace is configured to organize storage objects such as LUNs and file systems, and to track logical addresses of the storage objects such as address offsets into LUNs, file system addresses, and so on. A mapper is configured to map the logical addresses of the storage objects in the namespace to virtualization spaces (also referred to herein as “virtual pointers”) in the respective VLBs. For example, such a mapper may include multiple pointer arrays in a mapping hierarchy configured as a multi-level tree. Further, the lowest level of the multi-level tree may include an array of leaf pointers, each pointing to one of multiple virtual pointers in a respective VLB. Each such virtual pointer in the respective VLB is configured to point to data, such as a data block, in a respective PB.

### SUMMARY OF THE INVENTION

One aspect of the current technique is a method for improving write performance in a storage system. The method includes storing data on a first tier of storage. The method also includes storing a modification to the data on a second tier of storage, the second tier being higher than the first tier. The method also includes setting an indicator identifying which data is valid.

The method may also include adding a pointer to the data on the first tier of storage to a metadata structure, and adding a pointer to the modification of the data on the second tier of storage to the metadata structure. Setting the indicator may identify which pointer in the metadata structure points to valid data. Setting the indicator may include setting a bit in a bitmap.

A block of data may be stored on the first tier and a chunk of data may be stored on the second tier. The chunk of data may be smaller than the block of data.

The method may also include transferring the modification to the data to the first tier of storage, and resetting the indicator.

Another aspect of the current technique is a system, with a processor, for improving write performance in a storage system. The processor is configured to store data on a first tier of storage. The processor is also configured to store a modification to the data on a second tier of storage, the second tier being higher than the first tier. The processor is further configured to set an indicator identifying which data is valid. The processor may be configured to perform any other processes in conformance with the aspect of the current techniques described above.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 depicts an exemplary embodiment of a computer system that may utilize the techniques described herein;

FIG. 2 depicts an exemplary embodiment of a data storage system used in the computer system of FIG. 1;

FIG. 3 is an exemplary block diagram depicting a prior art example of the mapping layer, virtualization layer, and physical layer;

FIGS. 4 and 5 depicts exemplary VLBs that may be used in the virtualization layer of the data storage system of FIG. 2; and

FIGS. 6 and 7 are exemplary flow diagrams of methods for improving write performance in a storage system, according to techniques described herein.

### DETAILED DESCRIPTION OF EMBODIMENT(S)

Described below is a technique for improving write performance in a storage system, which technique may be used to provide, among other things, storing data on a first tier of storage; storing a modification to the data on a second tier of storage, the second tier being higher than the first tier; and setting an indicator identifying which data is valid.

To achieve high write performance, storage systems aggregate data from multiple, and potentially disparate (i.e., random), write requests into a larger block and transfer the block to storage. The mapping layer enables retrieval of the data by pointing to addresses corresponding to blocks of the stored data. For example, a storage system may aggregate, compress, and deduplicate data to obtain a block of 2.0 MB and store the block on a page on a hard disk drive. The mapping layer may be appended to include pointers to 4 KB blocks of data on the page. This technique reduces the overall number of disk accesses incurred by write requests, thereby diminishing the computing resources consumed by the storage system.

However, when stored data is subsequently altered or overwritten, write performance suffers, especially when written data is smaller than the native block size of storage (e.g., 4 KB overwrite in a 8 KB native block storage). Regardless of the amount of data impacted in a write request, the storage system must still retrieve a full page of data from storage. For example, for read-modify-write operations, a full page of data must be obtained and then decompressed and validated. The data is modified according to the write request, and the data is again prepared for storage. Thus, the data may be re-compressed, and its cyclic redundancy check (CRC) validation may be redetermined before the data is transferred back to storage. In this manner, even write requests on the order of 4 KB blocks incur substantial processing for, by way of example, 2.0 MB of data. Overhead of this magnitude greatly hampers input/output operations per second (IOPS).

To remedy this impact on write performance, the storage system stores data from write requests pertaining to a particular page on a storage tier higher than the page itself. The mapping layer stores pointers to the modifications to the page and includes a bitmap indicating which blocks of the page have been altered, but also retains pointers to the blocks of the unmodified data. Read requests can be serviced by using the bitmap to determine where the updated data for a given block resides. At a later time, the storage system can transfer all the modifications to the page to storage, and reset pointers and the bitmap accordingly.

In at least some implementations in accordance with the techniques as described herein, the use of write performance improvement techniques in storage systems can provide one or more of the following advantages: improved input/output operations per second (IOPS) performance for both write and read requests, particularly with respect to random write requests of blocks on the order of 4 KB.

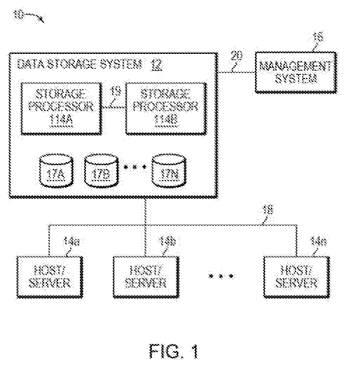

FIG. 1 depicts an example embodiment of a computer system 10 that may be used in connection with performing the techniques described herein. The system 10 includes one or more data storage systems 12 connected to server or hosts 14a-14n through communication medium 18. The system 10 also includes a management system 16 connected to one or more data storage systems 12 through communication medium 20. In this embodiment of the system 10, the management system 16, and the N servers or hosts 14a-14n may access the data storage systems 12, for example, in performing input/output (I/O) operations, data requests, and other operations. The communication medium 18 may be any one or more of a variety of networks or other type of communication connections as known to those skilled in the art. Each of the communication mediums 18 and 20 may be a network connection, bus, and/or other type of data link, such as a hardwire or other connections known in the art. For example, the communication medium 18 may be the Internet, an intranet, network or other wireless or other hardwired connection(s) by which the hosts 14a-14n may access and communicate with the data storage systems 12, and may also communicate with other components (not shown) that may be included in the system 10. In one embodiment, the communication medium 20 may be a LAN connection and the communication medium 18 may be an iSCSI, Fibre Channel, Serial Attached SCSI, or Fibre Channel over Ethernet connection.

Each of the hosts 14a-14n and the data storage systems 12 included in the system 10 may be connected to the communication medium 18 by any one of a variety of connections as may be provided and supported in accordance with the type of communication medium 18. Similarly, the management system 16 may be connected to the communication medium 20 by any one of variety of connections in accordance with the type of communication medium 20. The processors included in the hosts 14a-14n and management system 16 may be any one of a variety of proprietary or commercially available single or multi-processor system, or other type of commercially available processor able to support traffic in accordance with any embodiments described herein.

It should be noted that the particular examples of the hardware and software that may be included in the data storage systems 12 are described herein in more detail, and may vary with each particular embodiment. Each of the hosts 14a-14n, the management system 16 and data storage systems 12 may all be located at the same physical site, or, alternatively, may also be located in different physical locations. In connection with communication mediums 18 and 20, a variety of different communication protocols may be used such as SCSI, Fibre Channel, iSCSI, and the like. Some or all of the connections by which the hosts 14a-14n, management system 16, and data storage systems 12 may be connected to their respective communication medium 18, 20 may pass through other communication devices, such as switching equipment that may exist such as a phone line, a repeater, a multiplexer or even a satellite. In one embodiment, the hosts 14a-14n may communicate with the data storage systems 12 over an iSCSI or a Fibre Channel connection and the management system 16 may communicate with the data storage systems 12 over a separate network connection using TCP/IP. It should be noted that although FIG. 1 illustrates communications between the hosts 14a-14n and data storage systems 12 being over a first communication medium 18, and communications between the management system 16 and the data storage systems 12 being over a second different communication medium 20, other embodiments may use the same connection. The particular type and number of communication mediums and/or connections may vary in accordance with particulars of each embodiment.

Each of the hosts 14a-14n may perform different types of data operations in accordance with different types of tasks. In the embodiment of FIG. 1, any one of the hosts 14a-14n may issue a data request to the data storage systems 12 to perform a data operation. For example, an application executing on one of the hosts 14a-14n may perform a read or write operation resulting in one or more data requests to the data storage systems 12.

The management system 16 may be used in connection with management of the data storage systems 12. The management system 16 may include hardware and/or software components. The management system 16 may include one or more computer processors connected to one or more I/O devices such as, for example, a display or other output device, and an input device such as, for example, a keyboard, mouse, and the like. The management system 16 may, for example, display information about a current storage volume configuration, provision resources for a data storage system 12, and the like.

Each of the data storage systems 12 may include one or more data storage devices 17a-17n. Unless noted otherwise, data storage devices 17a-17n may be used interchangeably herein to refer to hard disk drive, solid state drives, and/or other known storage devices. One or more data storage devices 17a-17n may be manufactured by one or more different vendors. Each of the data storage systems included in 12 may be inter-connected (not shown). Additionally, the data storage systems 12 may also be connected to the hosts 14a-14n through any one or more communication connections that may vary with each particular embodiment. The type of communication connection used may vary with certain system parameters and requirements, such as those related to bandwidth and throughput required in accordance with a rate of I/O requests as may be issued by the hosts 14a-14n, for example, to the data storage systems 12. It should be noted that each of the data storage systems 12 may operate stand-alone, or may also be included as part of a storage area network (SAN) that includes, for example, other components such as other data storage systems 12. The particular data storage systems 12 and examples as described herein for purposes of illustration should not be construed as a limitation. Other types of commercially available data storage systems 12, as well as processors and hardware controlling access to these particular devices, may also be included in an embodiment.

In such an embodiment in which element 12 of FIG. 1 is implemented using one or more data storage systems 12, each of the data storage systems 12 may include code thereon for performing the techniques as described herein.

Servers or hosts, such as 14a-14n, provide data and access control information through channels on the communication medium 18 to the data storage systems 12, and the data storage systems 12 may also provide data to the host systems 14a-14n also through the channels 18. The hosts 14a-14n may not address the disk drives of the data storage systems 12 directly, but rather access to data may be provided to one or more hosts 14a-14n from what the hosts 14a-14n view as a plurality of logical devices or logical volumes (LVs). The LVs may or may not correspond to the actual disk drives. For example, one or more LVs may reside on a single physical disk drive. Data in a single data storage system 12 may be accessed by multiple hosts 14a-14n allowing the hosts 14a-14n to share the data residing therein. An LV or LUN (logical unit number) may be used to refer to the foregoing logically defined devices or volumes.

The data storage system 12 may be a single unitary data storage system, such as single data storage array, including two storage processors 114A, 114B or computer processing units. Techniques herein may be more generally use in connection with any one or more data storage system 12 each including a different number of storage processors 114 than as illustrated herein. The data storage system 12 may include a data storage array 116, including a plurality of data storage devices 17a-17n and two storage processors 114A, 114B. The storage processors 114A, 114B may include a central processing unit (CPU) and memory and ports (not shown) for communicating with one or more hosts 14a-14n. The storage processors 114A, 114B may be communicatively coupled via a communication medium such as storage processor bus 19. The storage processors 114A, 114B may be included in the data storage system 12 for processing requests and commands. In connection with performing techniques herein, an embodiment of the data storage system 12 may include multiple storage processors 114 including more than two storage processors as described. Additionally, the two storage processors 114A, 114B may be used in connection with failover processing when communicating with the management system 16. Client software on the management system 16 may be used in connection with performing data storage system management by issuing commands to the data storage system 12 and/or receiving responses from the data storage system 12 over connection 20. In one embodiment, the management system 16 may be a laptop or desktop computer system.

The particular data storage system 12 as described in this embodiment, or a particular device thereof, such as a disk, should not be construed as a limitation. Other types of commercially available data storage systems 12, as well as processors and hardware controlling access to these particular devices, may also be included in an embodiment.

In some arrangements, the data storage system 12 provides block-based storage by storing the data in blocks of logical storage units (LUNs) or volumes and addressing the blocks using logical block addresses (LBAs). In other arrangements, the data storage system 12 provides file-based storage by storing data as files of a file system and locating file data using inode structures. In yet other arrangements, the data storage system 12 stores LUNs and file systems, stores file systems within LUNs, and so on.

The two storage processors 114A, 114B (also referred to herein as “SP”) may control the operation of the data storage system 12. The processors may be configured to process requests as may be received from the hosts 14a-14n, other data storage systems 12, management system 16, and other components connected thereto. Each of the storage processors 114A, 114B may process received requests and operate independently and concurrently with respect to the other processor. With respect to data storage management requests, operations, and the like, as may be received from a client, such as the management system 16 of FIG. 1 in connection with the techniques herein, the client may interact with a designated one of the two storage processors 114A, 114B. Upon the occurrence of failure of one the storage processors 114A, 114B, the other remaining storage processors 114A, 114B may handle all processing typically performed by both storage processors 114A.

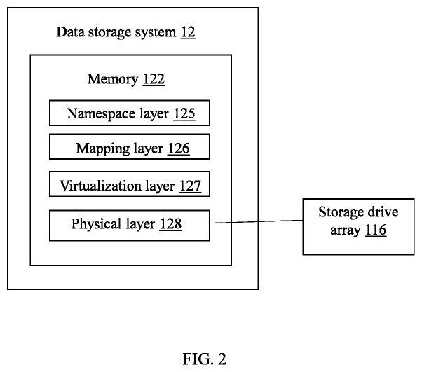

FIG. 2 depicts an exemplary embodiment of a data storage system 12 used in the computer system 10 of FIG. 1. In addition to the storage processors 114A, 114B and data storage devices 17a-17n depicted in FIG. 1, the data storage system 12 can include a memory 122. The memory 122 can include persistent memory (e.g., flash memory, magnetic memory) and non-persistent memory (e.g., dynamic random access memory (DRAM), static random access memory (SRAM)), and can accommodate a variety of specialized software constructs, including, but not limited to, a namespace layer 125, a mapping layer 126, a virtualization layer 127, a physical layer 128, and/or any other suitable software constructs.

The namespace layer 125 is a logical structure configured to organize storage objects such as VVOLs, LUNs, file systems, and/or any other suitable storage objects, accessible to the plurality of hosts 14a-14n. The namespace layer 125 can track logical addresses of storage objects, such as offsets into LUNs or file system addresses. For example, if a LUN made up of one or more extents were to have a maximum size of 10 gigabytes (Gb), then the namespace layer 125 may provide a 10 Gb logical address range to accommodate the LUN.

The mapping layer 126 is a logical structure configured to map the logical addresses of the storage objects in the namespace layer 125 to virtualization structures (also referred to herein as “virtual pointers”) in the virtualization layer 127. To that end, the mapping layer 126 can include multiple pointer arrays (e.g., indirect pointer arrays) in a mapping hierarchy configured as a multi-level tree. For example, such a pointer array may include a pointer to a child pointer array, and may be pointed to by a pointer in a parent pointer array.

The virtualization layer 127 is a logical structure configured to provide block virtualization. For example, the virtualization layer 127 may have an aggregation of virtual layer blocks (VLBs), each of which may include a plurality of virtual pointers (e.g., 512 virtual pointers). Further, the lowest level of the multi-level tree in the mapping layer 126 may include an array of leaf pointers, each of which may point to one of the virtual pointers included in a respective VLB of the virtualization layer 127.

The physical layer 128 is configured to store an aggregation of physical layer blocks (PLBs). For example, such a PLB may include an aggregation of compressed data blocks, individually compressed data blocks, and/or uncompressed data blocks. Further, each virtual pointer included in a respective VLB of the virtualization layer 127 may point to a data block in a respective PLB of the physical layer 128. It is noted that, although the physical layer 128 is described herein using the term “physical”, an underlying storage drive array 116 is typically responsible for the actual, physical storage of host data. The storage drive array 116 can include the storage devices 17a-17n depicted in FIG. 1. The storage drive array 116 may include magnetic disk drives, electronic flash drives, optical drives, and/or any other suitable physical drives. The storage drive array 116 can be attached to one or more I/O channels of the data storage system 12, while also being accessible over the network 18.

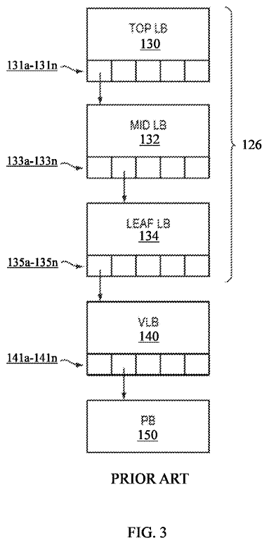

FIG. 3 is an exemplary block diagram depicting a prior art example of the mapping layer 126, virtualization layer 127, and physical layer 128. In this embodiment, the mapping layer 126 includes a collection of logical blocks organized in a tree structure with three levels: the top-level logical blocks (top LBs) 130, the mid-level logical blocks (mid LBs) 132, and the leaf logical blocks (leaf LBs) 134. Various embodiments of the mapping layer 126 may include tree structures with other numbers of levels, such as a two-level tree, or a flat table that maps logical locations with physical locations.

In some embodiments, a top LB 130 has one or more pointers 131a-n associated with it. In some embodiments the one or more pointers 131a-n are located within the top LB 130 at indices, whereby each of the one or more pointers 131a-n is located at a different index within the top LB 110. In some embodiments, the one or more pointers 131a-n each point to a mid LB 132.

In some embodiments, each mid LB 111320 has one or more pointers 133a-n associated with it. In some embodiments the one or more pointers 133a-n are located within each of the respective one or more mid LBs 132 at indices, whereby each of the one or more pointers 133a-n is located at a different index within each of the respective one or more mid LBs 132. In some embodiments, the one or more pointers 133a-n each point to a leaf LB 134.

In some embodiments, each leaf LB 134 has one or more pointers 135a-n associated with it. In some embodiments, the one or more pointers 135a-n are located within each of the respective one or more leaf LBs 134 at indices, whereby each of the one or more pointers 135a-n is located at a different index within each of the respective one or more leaf LBs 134. In some embodiments, the one or more pointers 135a-n each point to a virtual block (VLB) 140.

Although the embodiment in FIG. 3 depicts logical blocks organized in a three-level tree structure, in various embodiments, the tree structure may have other numbers of levels that are organized and described according to other schema. For example, a four-level tree may include super blocks, which point to top indirect blocks. Top indirect blocks may point to mid indirect blocks, and mid indirect blocks may point to leaf indirect blocks. Finally, the leaf indirect blocks may point to virtual blocks VLB 40.

In some embodiments, each VLB 140 has one or more pointers 141a-n associated with it. In some embodiments, the one or more pointers 141a-n are located within each of the respective one or more VLBs 140 at indices, whereby each of the one or more pointers 141a-n is located at a different index within each of the respective one or more VLBs 140. In some embodiments, the one or more pointers 141a-n each point to a block (PB) 150 in physical storage.

In the prior art, the pointers 131a-n, 133a-n, 135a-n, and 141a-n are a combination of an address of the block pointed to and an index within the pointed-to block. In some embodiments, the address of the block pointed to and the index within the pointed-to block are encoded into a single value. In some embodiments, the address of the block pointed-to and the index within the pointed-to block are stored as separate values and used together or combined when needed (e.g., when locating the actual contents at the specific location being referenced). In this way, the mapping layer 126, virtualization layer 127, and physical layer 128 can be traversed by following the pointers.

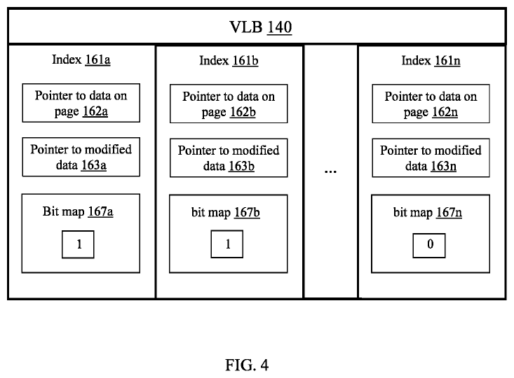

FIG. 4 depicts an exemplary VLB 140 in the virtualization layer used in the data storage system of FIG. 2. The VLB 140 has indices 161a-n (“161”) corresponding to blocks of stored data. An index 161 for a block includes a pointer 162 to the block's address and a bitmap 162 indicating the validity of the data therein. In this embodiment, when the storage system 12 receives a write request to modify a particular block, the data for the modification is stored on a higher tier of storage than the page itself, and a pointer 163 to the modified data is stored in the VLB 140. The bitmap 167 is altered to indicate that the block has been modified.

As a result, when the storage system 12 receives a read request, the system 12 first identifies the indices 161 in the VLB 140 that correspond to the data in the request. The bitmap 167 indicates, for any given block, where the associated valid data resides. If the data has not been modified since the page was transferred to storage, the storage system 12 retrieves data based on the pointer 162. Otherwise, the pointer 163 is used to obtain the valid data. In this manner, the storage system 12 can traverse the indices 161 pertinent to the read request, accessing valid data wherever it may be stored and bypassing data that is no longer valid.

In some embodiments, the storage system 12 executes a process to transfer all data modifications to the stored page. Valid data is retrieved from the plurality of storage devices where it has been stored, and processed via compression, deduplication, or any other technique performed on data to be stored. The storage system 12 may store the page, with all of its modifications, on a hard drive disk. Every pointer 162 is updated to the address of its corresponding block of data, and each entry in the bitmap 167 is reset so as to recognize the pointer 162 as pointing to valid data.

In various embodiments, the transfer of data modifications to storage may be executed as part of a background process. The storage system 12 may perform such transfer during periods of relative inactivity, or in conjunction with processes to re-tier data, according to its patterns of activity. In further embodiments, transfer may occur when the storage system 12 subjects the VLB 140 to defragmentation.

The size of the blocks of data may be 2 KB, 4 KB, 8 KB, or any other size. Because the size impacts the numbers of indices 161 required in the VLB 140, smaller sized blocks result in higher ratios of metadata to data stored compared to larger sized blocks. Using larger sized blocks may be advantageous in reducing the amount of memory consumed by metadata and achieving superior write performance due to the larger block write.

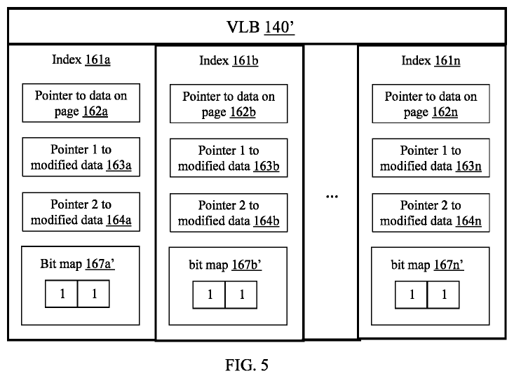

In some embodiments, the size of the block is larger than the smallest chunk of data that can be written/overwritten. For example, the storage system 12 may use blocks of 8 KB, but be capable of data writes of 4K. FIG. 5 depicts an exemplary VLB 140′ used in such storage systems 12. Like the VLB 140 of FIG. 4, the VLB 140′ has indices 161a-n corresponding to blocks of stored data, each of which includes a pointer 162a-n to the corresponding block's address. An index 161 may store additional pointers 163, 164 to chunks of data within the block. Thus, in a storage system 12 using blocks of 8 KB, one pointer 163 may point to the first 4 KB chunk of data, while the second pointer 164 points to the subsequent 4 KB chunk of data. The bitmap 167 indicates the validity of any given chunk of data.

When the storage system 12 first transfers a page of data to storage, the bitmap 167 entries are all reset. When the storage system 12 receives a write request of 4 KB, the storage system 12 identifies the index 161, block, and chunk of data impacted by the request. The data for the modification is stored on a higher tier of storage than the page itself, and a pointer to the data is added to the VLB 140′. If the data pertains to the first chunk within the block, the address is added as pointer 163. If the data pertains to the second chunk, the address is added as pointer 164. The corresponding bit in the bitmap 167′ is set to indicate that the data for that chunk on the page is invalid, and the valid data is stored at pointer 163, 164. If a write request impacts more than 4 KB of data, the storage system 12 identifies all indices 161, blocks, and chunks of data affected, and performs the techniques described herein. In various embodiments, the storage system 12 executes a process to transfer all data modifications to the stored page, according to any of the techniques described herein.

When the storage system 12 receives a read request, the system 12 first identifies the indices 161 in the VLB 140′ that correspond to the data in the request. The bitmap 167′ indicates, for any given chunk within the block(s), where the associated valid data resides. In some situations, both bits for a block remain reset in the bitmap 167′. Thus, the block has not been modified since the data was transferred to storage, and the storage system 12 accesses the 8 KB of data at pointer 162. If either bit remains reset, the storage system 12 uses the pointer 162 to retrieve the corresponding 4 KB chunk of data. If the first bit in the bitmap 167′ has been set, the storage system 12 accesses the 4 KB chunk of data at pointer 163. If the second bit has been set, a 4 KB chunk of data is retrieved based on pointer 164. Thus, to process a read request, the storage system 12 can traverse the indices 161 associated with the requested data to access valid data wherever it may be stored and bypass data that is no longer valid.

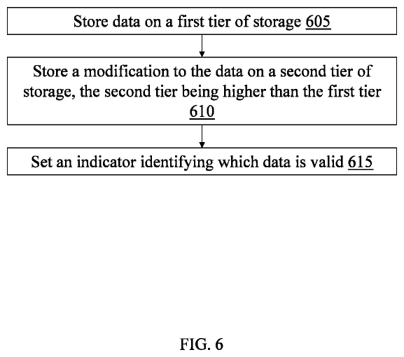

FIG. 6 is an exemplary flow diagram 600 of a method for improving write performance in a storage system. The storage system stores data on a first tier of storage (step 605). The storage system stores a modification to the data on a second tier of storage, the second tier being higher than the first tier (step 610). The storage system 12 sets an indicator identifying valid data (step 615).

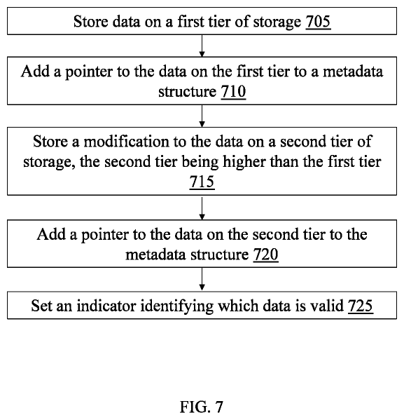

FIG. 7 is an exemplary flow diagram 700 of a method for improving write performance in a storage system. The storage system stores data on a first tier of storage (step 705). A pointer to the data on the first tier is added to a metadata structure (step 710). The storage system stores a modification to the data on a second tier of storage, the second tier being higher than the first tier (step 715). A pointer to the data on the second tier is added to the metadata structure (step 720). The storage system 12 sets an indicator identifying valid data (step 720).

In some embodiments, the storage system 12 stores the data in memory. Alternatively, the storage system 12 simply delays transfer of the data to storage, instead of storing the data on a higher tier of storage.

It should again be emphasized that the implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

1. A method for improving write performance in a storage system, the method comprising:
storing a set of blocks of data on a first tier of the storage system;
storing, in a metadata structure, pointers to each block in the set of blocks stored on the first tier;
storing on a second tier of the storage system that is higher than the first tier, a modification to a subset of the set of blocks of data;
storing, in the metadata structure, pointers to each block in the modification stored on the second tier; and
setting, for each block in the modification to the data, an indicator identifying the block of data stored on the second tier as valid.

2-3. (canceled)

4. The method of claim 1, wherein setting the indicators comprises:
setting at least one bit in a bitmap.

5. The method of claim 1, further comprising:
transferring the modification to the data to the first tier of the storage system; and
resetting the indicator for each block corresponding to the modification to the data.

6-7. (canceled)

8. A system for improving write performance in a storage system, the system including a processor configured to:
store a set of blocks of data on a first tier of the storage;
store, in a metadata structure, pointers to each block in the set of blocks stored on the first tier;
store, on a second tier of the storage system that is higher than the first tier, a modification to a subset of the set of blocks of the data;
store, in the metadata structure, pointers to each block in the modification stored on the second tier; and
set, for each block in the modification to the data, an indicator identifying the block of data stored on the second tier as valid.

9-10. (canceled)

11. The system of claim 8, wherein the processor is further configured to:
set at least one bit in a bitmap.

12. The system of claim 8, wherein the processor is further configured to:
transfer the modification to the data to the first tier of the storage system; and
reset the indicator for each block corresponding to the modification to the data.

13-14. (canceled)

15. The method of claim 1, wherein storing, in the metadata structure, the pointers to each block in the set of blocks stored on the first tier comprises:
storing, in the metadata structure, pointers to each chunk in each block of the data, wherein each block includes more than one chunk.

16. The method of claim 15, wherein the block of data is 8 KB and the chunk of data is 4 KB.

17. The method of claim 15, wherein storing, in the metadata structure, the pointers to each block in the modification stored on the second tier comprises:
storing, in the metadata structure, pointers to each chunk of data in the modification, wherein each block includes more than one chunk.

18. The method of claim 17, wherein setting, for each block in the modification to the data, the indicator identifying the block of data stored on the second tier as valid comprises:
setting indicators corresponding to each chunk in the modification to the data.

19. The method of claim 17, wherein setting, for each block in the modification to the data, the indicator identifying the block of data stored on the second tier as valid comprises:
setting at least one bit in a bitmap.

20. The method of claim 18, further comprising:
receiving a read request for the set of blocks of the data;
traversing the indicators identifying the valid data;
for each indicator, retrieving either the corresponding chunk of data stored on the first tier of storage or the corresponding chunk of data stored on the second tier of storage.

21. The method of claim 18, wherein transferring the modification to the data to the first tier of storage comprises:
transferring the chunks of the modifications to the data stored on the second tier to the first tier of storage.

22. The system of claim 8, wherein the processor is further configured to:
store, in the metadata structure, pointers to each chunk in each block of the data on the first tier, wherein each block includes more than one chunk.

23. The system of claim 22, wherein the block of data is 8 KB and the chunk of data is 4 KB.

24. The system of claim 22, wherein the processor is further configured to:
store, in the metadata structure, pointers to each chunk of data in the modification on the second tier, wherein each block includes more than one chunk.

25. The system of claim 24, wherein the processor is further configured to:
set indicators corresponding to each chunk in the modification to the data.

26. The system of claim 25, wherein the processor is further configured to:
set at least one bit in a bitmap.

27. The system of claim 25, wherein the processor is further configured to:
receive a read request for the set of blocks of the data;
traverse the indicators identifying the valid data;
for each indicator, retrieve either the corresponding chunk of data stored on the first tier of storage or the corresponding chunk of data stored on the second tier of storage.

28. The system of claim 24, wherein the processor is further configured to:
transfer the chunks of the modifications to the data stored on the second tier to the first tier of storage.
